(19) United States
(12) Patent Application Publication
(10) Pub. No.: US 2003/0085880 A1
(43) Pub. Date: May 8, 2003

(54) Computer keyboard with mouse pad

(76) Inventor: Kyung-Chul Lee, New York, NY (US)

Correspondence Address: PENNIE AND EDMONDS, 1155 AVENUE OF THE AMERICAS, NEW YORK, NY, 100362711

(21) Appl. No.: 10/006,614

(22) Filed: Nov. 2, 2001

(51) Int. Cl. G09G 5/00

(52) U.S. Cl. 345/168

(57) ABSTRACT

An improved computer keyboard that integrates a computer keyboard with a mouse pad. In a preferred embodiment, the computer keyboard includes a left keyboard section, a right keyboard section, and a mouse pad connecting the left and right keyboard sections. The left keyboard section preferably includes alphanumeric keys, functions keys, and other keys usually grouped together with those keys in conventional keyboards. The right keyboard section preferably includes a numeric keypad, cursor keys, and other keys usually grouped together with those keys in conventional keyboards. The mouse pad is preferably a smooth surface of rectangular or circular shape made up of plastic or metal material that connects the left and right keyboard sections and houses electrical wires that connects the keyboard sections. A second mouse pad may be placed on top of the first mouse pad depending on the preferences of the user.

### FIELD OF THE INVENTION

The present invention relates generally to a computer keyboard and, more specifically, to a computer keyboard with an integrated mouse pad.

### BACKGROUND OF THE INVENTION

In a typical computer system, a mouse pad and a keyboard are usually separate components. When a computer user adjusts typing position, it is necessary to move each component individually. In addition, the mouse pad and keyboard may be inadvertently moved apart while the computer is not being used, requiring the computer user to re-orient them when he or she returns to the computer. These inconveniences may be avoided if the mouse pad and the keyboard are integrated into one single unit. In addition, by integrating the mouse pad to the keyboard, the two components are close to one another at all time so that arm movements of a user is minimized, improving ergonomics.

Various design and utility patents disclose keyboards with integrated mouse pads. For example, design Pat. No. 374,868 to Craft describes a mouse pad attached to a keyboard such that the mouse pad hovers above it. In addition, design Pat. No. 442,591 to Bailly claims a circular keyboard with an integrated circular mouse pad. However, these designs are highly unconventional, raising doubts regarding their practicality.

Utility U.S. Pat. Nos. 5,644,338 and 5,502,460 to Bowen disclose keyboards whose alphanumeric keys can be separated into two half-sections to reveal an “activities” area between the sections which can be used as a mouse pad. Although keyboards with split-key configurations (FIG. 6) are commonplace, splitting the alphanumeric keys so wide as to be able to accommodate a mouse pad in the Bowen keyboard creates an unconventional keyboard configuration, raising doubts regarding the practicality of the design. In addition, its construction is complex since maintaining connection of internal wires to the keys while allowing manual separation of the keys require additional components and manufacturing considerations not required for the conventional keyboard.

Therefore, there is a need for a device that integrates a conventional keyboard with a mouse pad that is practical yet simple in construction.

### SUMMARY OF THE INVENTION

Briefly, the present invention provides an improved computer keyboard that integrates a computer keyboard with a mouse pad. In a preferred embodiment, the computer keyboard includes a left keyboard section, a right keyboard section, and a mouse pad connecting the left and right keyboard sections. The left keyboard section preferably includes alphanumeric keys, function keys, and other keys usually grouped together with those keys in conventional keyboards. The right keyboard section preferably includes a numeric keypad, cursor keys, and other keys usually grouped together with those keys in conventional keyboards. The mouse pad is preferably a smooth surface of rectangular or circular shape made up of plastic, metal, glass, or fabric material or a combination of such materials that connects the left and right keyboard sections and may house electrical wires that connect the keyboard sections. An additional mouse pad may be placed on top of the mouse pad to vary its surface texture or design. In an alternative embodiment, the mouse pad is formed with an indentation of size and shape to house a second mouse pad. In a second alternative embodiment, the mouse pad may simply be coupled to (e.g., attached to or formed on) the left or right hand side of a keyboard so that the keyboard is not divided into sections by the mouse pad.

### BRIEF DESCRIPTION OF THE DRAWINGS

FIG. 1 is a perspective view of a keyboard with a mouse pad formed in accordance with the principles of the present invention;

FIG. 2 is a front elevational view of the keyboard of FIG. 1;

FIG. 3 is a side elevational view of the keyboard of FIG. 1;

FIG. 4 illustrates an alternative embodiment according to the invention with a mouse pad having an indentation for housing a second mouse pad;

FIG. 5 illustrates a side sectional view of the keyboard of FIG. 4;

FIG. 6 is a perspective view of a second alternative embodiment according to the invention with a circular mouse pad;

FIG. 7 is a plan view of a third alternative embodiment according to the invention with a circular mouse pad and a split-key keyboard;

FIG. 8 is a plan view of a fourth alternative embodiment according to the invention with a split-key keyboard; and

FIG. 9 is a perspective view of a fifth alternative embodiment according to the invention with a mouse pad coupled to the left-hand side of the keyboard.

### DETAILED DESCRIPTION OF PREFERRED EMBODIMENTS

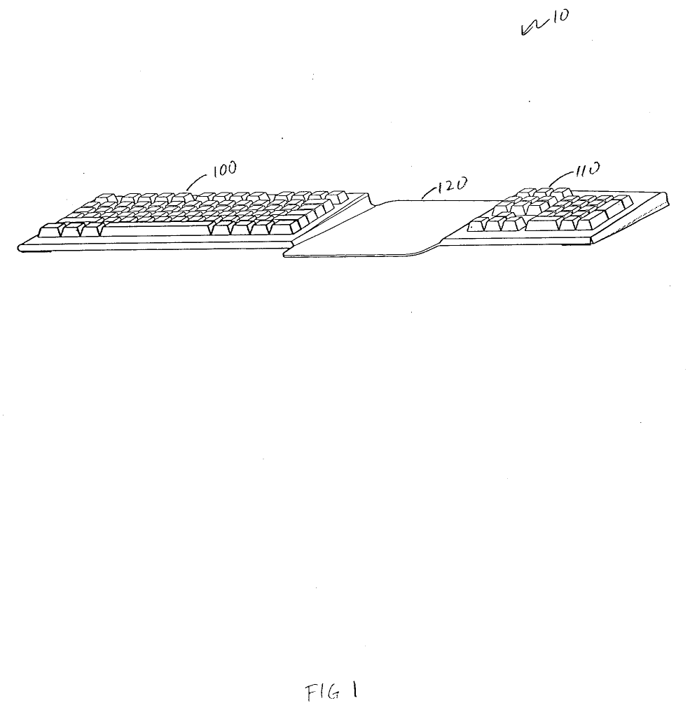

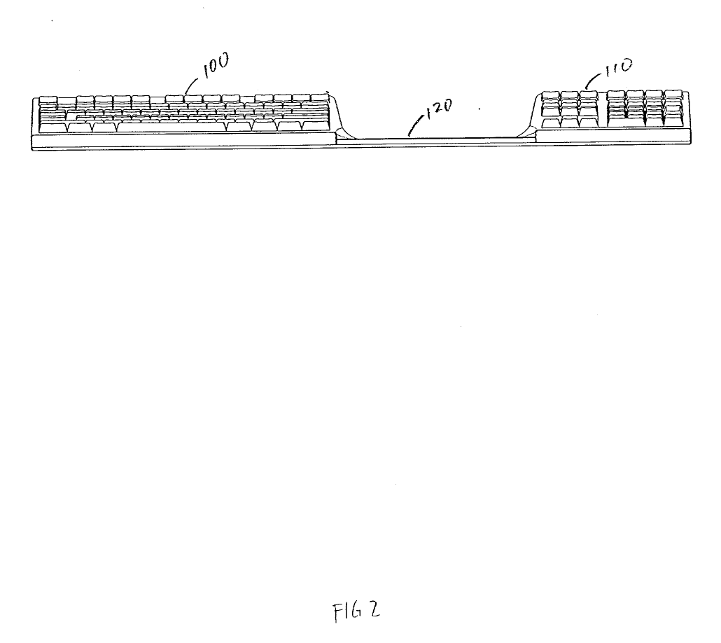

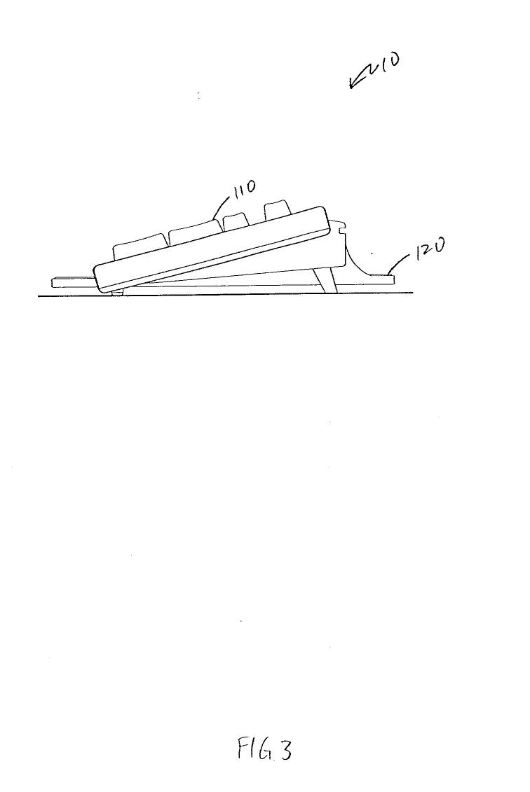

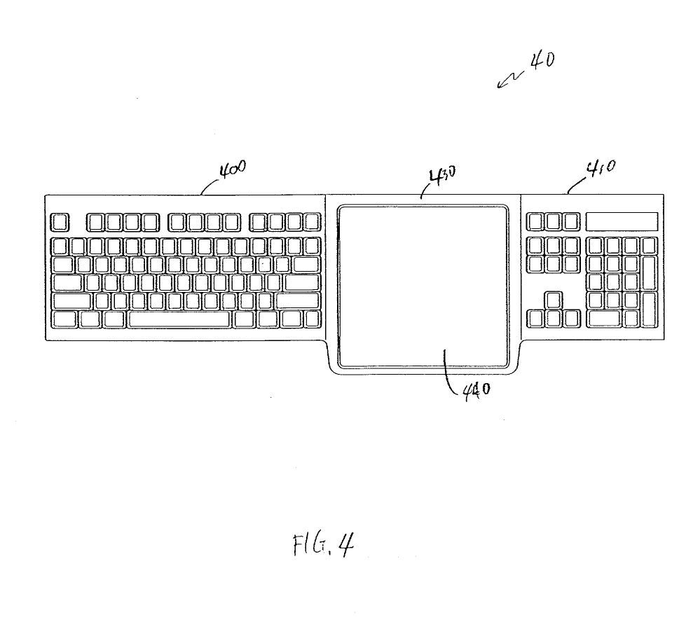

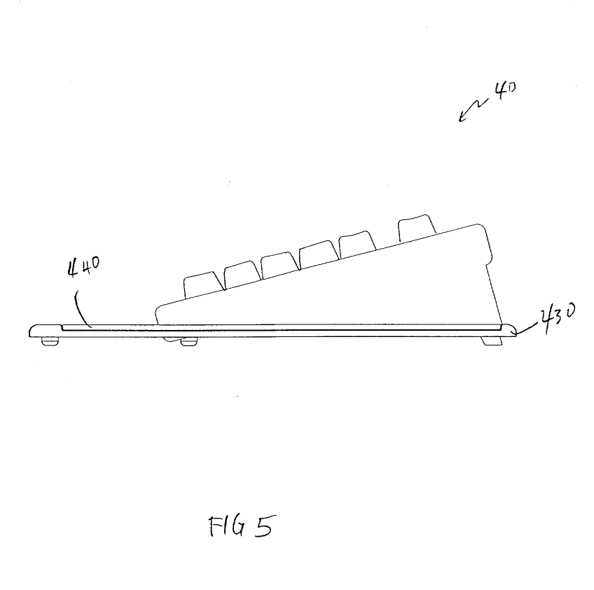

FIGS. 1, 2, and 3 illustrate an exemplary keyboard 10 embodying the principles of the present invention. As shown in the figures, keyboard 10 preferably includes left and right sections of a conventional keyboard 100 and 110 and a mouse pad 120 coupled to the two sections. Left keyboard section 100 and right keyboard section 110 generally are formed as distinct and separate keyboard sections at least somewhat spaced apart from each other and include keys of a first and second categories, respectively, where the first category is distinct from the second cateory. Keys of the first category on left keyboard section 100 preferably includes alphanumeric keys, functions keys, and other keys usually grouped together with those keys in conventional keyboards. Keys of the second category on right keyboard section 110 preferably includes a numeric keypad, cursor keys, and other keys usually grouped together with those keys in conventional keyboards. Thus, key categories are understood herein as groupings of keys known in the art to be associated with each other and kept together in keyboards. Mouse pad 120 of keyboard 10 is preferably a smooth flat surface of plastic, metal, glass, or fabric material and connects to the right hand side of left keyboard section 100 and to the left hand side of right keyboard sections 100 and 110. In addition, mouse pad 120 preferably houses wires that electrically connect the two sections. A second mouse pad such as an off-the shelf mouse pad may be placed on top of mouse pad 120 if the user prefers a different surface texture or design for the mouse pad. The material for mouse pad 120 may be rigid or flexible so as to limit or allow movement of the keyboard sections relative to one another. In an alternative embodiment 40 in accordance with the present invention (FIGS. 4 and 5), mouse pad 430 is preferably formed with an indentation of size and shape that can hold a second mouse pad 440 so that mouse pad 440 does not become easily separated from keyboard 70.

It should be noted that the grouping of the keys in keyboard 10 is not unlike that of a conventional keyboard. Specifically, in a conventional keyboard, as in keyboard 10, keys of the first category are separated from keys of the second category. Therefore, although the design of keyboard 10 represents a departure from conventional keyboards, the similarity in the grouping of keys allows keyboard 10 to remain familiar to users while, at the same time, enhancing its practical value by the integrating mouse pad 120.

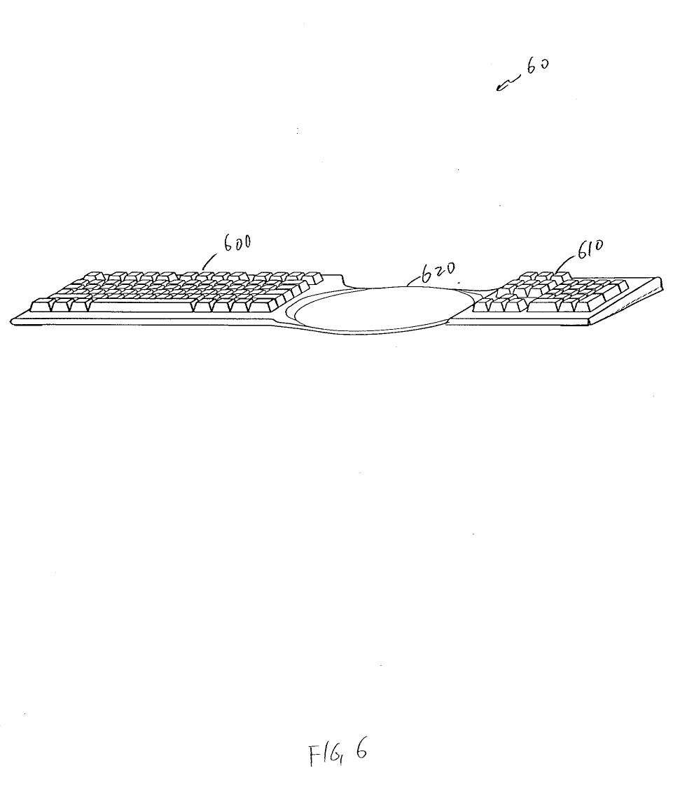

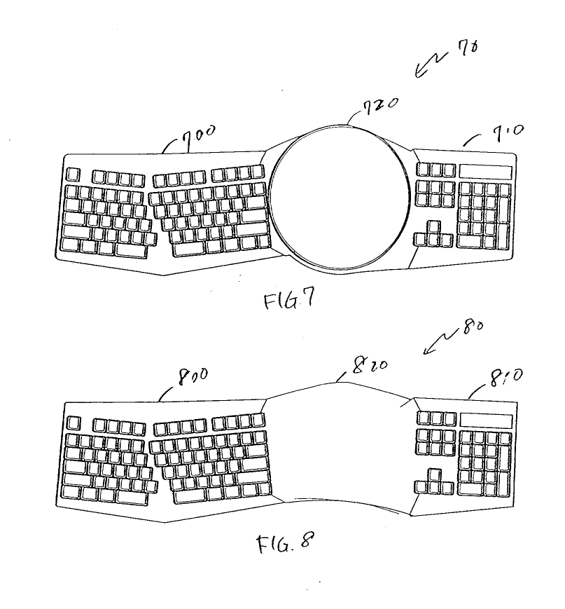

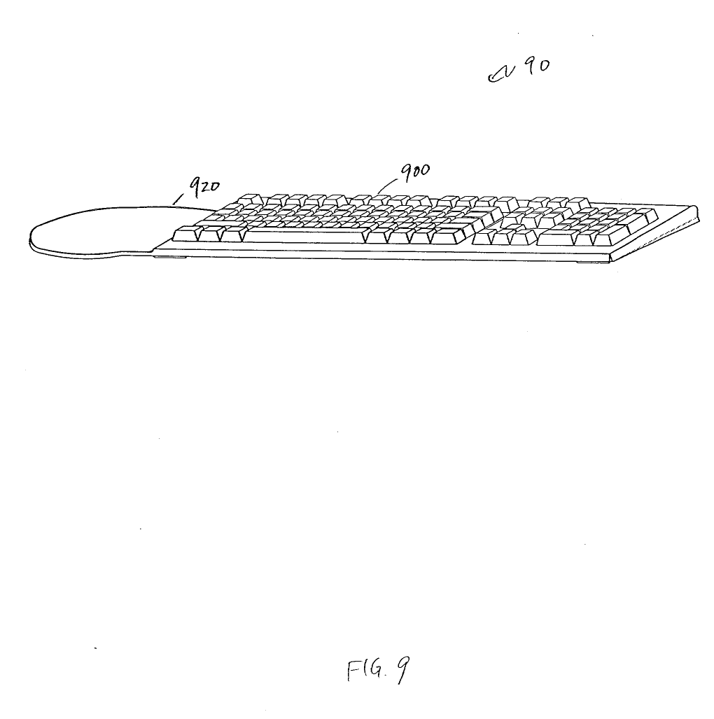

FIG. 6 illustrates a first alternative embodiment 60 in accordance with the present invention. Keyboard 60 is similar to keyboard 10 (FIGS. 1, 2, and 3) with the predominant difference being that mouse pad 620 is circular in shape. FIG. 7 illustrates a second alternative embodiment 70 in accordance with the present invention. Keyboard 70 is similar to keyboard 60 (FIG. 6) with the predominant difference being that the alphanumeric keys are arranged in a split-key configuration. In other alternative embodiments, the mouse pad may be oval or any of various other shapes including free-form shapes such as illustrated in FIG. 8.

FIG. 9 illustrates a fourth alternative embodiment 90 in accordance with the present invention. Keyboard 90 preferably includes a conventional keyboard 900 with an integrated mouse pad 920 coupled to the left hand side of the keyboard to accommodate left-handed computer users. In this embodiment, mouse pad 920 does not divide the keys into sections, and, therefore, is not required to house any electric wires to connect various sections of the keyboard. In an alternative embodiment, the mouse pad may be coupled to the right hand side of the entire keyboard rather than the left hand side. In both embodiments, mouse pad 920 may be coupled to keyboard 90 in any desired manner. For instance, mouse pad 920 may be separately formed from and then attached to keyboard 90. Alternatively, mouse pad 920 and keyboard 90 may be integrally formed as a monolithic piece.

While the invention has been described in conjunction with specific embodiments, it is evident that numerous alternatives, modifications, and variations will be apparent to those skilled in the art in light of the forgoing descriptions. For example, the two sections of the keyboard and the mouse pad may be made detachable so that mouse pads of different shapes and materials may be substituted and the location of the mouse pad with respect to the two sections of the keyboard may be varied. Furthermore, the left and right keyboard sections may be composed of different configurations of keys of a conventional keyboard. The scope of this invention is defined only by the following claims.

What is claimed is:

1. A computer keyboard comprising:
(a) a left keyboard section including keys of a first category and having a left hand side and a right hand side;
(b) a right keyboard section including keys of a second category distinct from said first category, said right keyboard section having a left hand side and a right hand side; and
(c) a mouse pad having a left hand side and a right hand side, wherein said mouse pad is coupled to said right hand side of said left keyboard section on said left hand side of said mouse pad and to said left hand side of said right keyboard section on said right hand side of said mouse pad.

2. The keyboard according to claim 1, wherein said keys of first category comprises at least alphanumeric keys.

3. The keyboard according to claim 2, wherein said keys of first category further comprises functions keys and other keys usually grouped together with said alphanumeric and said function keys in conventional keyboards.

4. The keyboard according to claim 1, wherein said keys of second category comprises a numeric keypad.

5. The keyboard according to claim 4, wherein said keys of second category further comprises cursor keys and other keys usually grouped together with said numeric keypad and said cursor keys in conventional keyboards.

6. The keyboard according to claim 1, wherein said mouse pad is rectangular in shape.

7. The keyboard according to claim 1, wherein said mouse pad is circular in shape.

8. The keyboard according to claim 1, wherein said mouse pad is made up of plastic material.

9. The keyboard according to claim 1, wherein said mouse pad is made up of metallic material.

10. The keyboard according to claim 1, wherein said mouse pad is made up of glass.

11. The keyboard according to claim 1, wherein said mouse pad is made up of fabric material.

12. The keyboard according to claim 1, further comprising a second mouse pad placed on top of said mouse pad.

13. The keyboard according to claim 12, wherein said mouse pad comprises an indentation for housing said second mouse pad.

14. The keyboard according to claim 1, wherein said mouse pad comprises an indentation for housing a second mouse pad.

15. The keyboard according to claim 1, further comprising electrical connections housed within said mouse pad that electrically connect said left keyboard section and said right keyboard section.

16. The keyboard according to claim 3, wherein said left keyboard section is arranged in a split-key configuration.

17. A computer keyboard comprising:
(a) a computer keyboard having a right hand side and a left hand side; and
(c) a mouse pad coupled to at least one of said left hand side or said right hand side of said computer keyboard.

18. The computer keyboard according to claim 16, wherein said computer keyboard and said mouse pad form one monolithic device.

19. The computer keyboard according to claim 16, wherein said mouse pad is attached to said left hand side of said computer keyboard.

20. The computer keyboard according to claim 16, wherein said mouse pad is attached to said right hand side of said computer keyboard.

21. The keyboard according to claim 16, further comprising a second mouse pad placed on top of said mouse pad.

22. The keyboard according to claim 12, wherein said mouse pad comprises an indentation for housing said second mouse pad.

23. The keyboard according to claim 16, wherein said mouse pad comprises an indentation for housing a second mouse pad.
